(19) United States
(12) Patent Application Publication
(10) Pub. No.: US 2008/0104648 A1
(43) Pub. Date: May 1, 2008

(54) System for providing a video service, and apparatus and method for the same

(75) Inventors: Kyung-Ho Chae, Seoul (KR); Sung-Jea Ko, Seoul (KR); Jeong-Rok Park, Hwaseong-si (KR); Yun-Je Oh, Yongin-si (KR); Jeong-Seok Choi, Yongin-si (KR); Young-Hun Joo, Yongin-si (KR); Hye-Soo Kim, Seoul (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/977,599

(22) Filed: Oct. 25, 2007

(30) Foreign Application Priority Data
Oct. 25, 2006 (KR) 103807/2006

(51) Int. Cl. H04N 7/24

(52) U.S. Cl. 725/114; 375/E07.011; 375/240.02

(57) ABSTRACT

A method, apparatus and system for providing a video service of a video service system including multimedia video in real time to a mobile terminal connected by a wireless network. A video frame coded by a coding scheme is transmitted to the mobile terminal for decoding and display. The coding scheme may include a first coding scheme and a second coding scheme used together at a predetermined ratio according to the mobile terminal demanding the video service. A server typically receives coding scheme change determining information from the mobile terminal in order to determining whether or not to change the coding scheme for the video frame during transmission of the video frame. The changed coding scheme can be used to transmit the video frame to the mobile terminal according to the result of analyzing the coding scheme change determining information.

### CLAIM OF PRIORITY

This application claims the benefit under 35 U.S.C. §119(a) from an application entitled “System for Providing a Video Service, and Apparatus and Method for the Same,” filed in the Korean Intellectual Property Office on Oct. 25, 2006 and assigned Serial No. 2006-103807, the contents of which are hereby incorporated by reference in its entirety.

### BACKGROUND OF THE INVENTION

1. Field of the Invention

The present invention relates to a system, apparatus, and method for providing a video service. More particularly, the present invention relates to an apparatus and a method for providing a multimedia video service in real time to a mobile terminal connected by a wireless network.

2. Description of the Related Art

In order to provide multimedia application service when the available bandwidth is relatively limited, techniques such as the MPEG4/H.264 compression technology uses schemes such as a motion compensation and prediction scheme, discrete cosine transform, vector quantization, variable length encoding, etc., to reduce the bandwidth required when providing multimedia service.

The prediction scheme is used to provide inter-coding, and thereby has a large impact on improving compression efficiency. Inter-coding is a method that compares a macro block of a previous frame with a macro block of a current frame in order, and encodes the difference value on the basis of the prediction scheme.

More particularly, an inter-coding method of a moving picture includes one I-frame (intra-frame) and a plurality of P-frames (predict-frames) for each time. In coding, the I-frame is independently encoded regardless of adjacent frames (intra-coded), and P-frames are predict-frames referring to a temporally adjacent I-frame or P-frame. Typically, the intra-coding is used for coding of the I frame, and the inter-coding is used for coding of the P-frame. However, if a new part, which is not included in the I-frame, is found in the P-frame, then intra-coding can be performed for the corresponding P-frame. Therefore, the moving picture is encoded by using the intra-coding and inter-coding together at the specific ratio.

Accordingly, in order to restore the inter-coded frame, a frame that was previously encoded and reconstructed is used as a basis for the restoration. However, the loss of information in one frame can have a considerable effect on image quality of a subsequent frame. Therefore, even a slight transmission error can have considerable impact, sometimes breaking a video bit stream. Therefore, the prediction scheme of inter-coding is particularly vulnerable to transmission problems, as the error may be spread to a subsequent reference frame unless special solutions are not provided.

To this end, Automatic Repeat Request (ARQ), Forward Error Correction (FEC) and error concealment have been developed to provide some limited means of preventing the complete break-down of a video bit stream. However, it is very difficult to implement the aforementioned compression and prediction schemes and completely prevent temporal error propagation.

### SUMMARY OF THE INVENTION

Accordingly, the present invention has been made in part at least to solve some of the above-mentioned problems occurring in the prior art, as well as provide other advantages. The present invention provides a system, apparatus and method for providing a video service that is resistant to error propagation.

In accordance with an exemplary aspect of the present invention, there is provided a method for providing a video service of a video service system, which provides a multimedia video service in real time, to a mobile terminal connected by a wireless network. the method including the steps of: transmitting a video frame to a mobile terminal demanding the video service, in which the frame is coded by a coding scheme comprising a first coding scheme and a second coding scheme together at a predetermined ratio; receiving coding scheme change determining information for determining whether or not to change the coding scheme of the video frame from the mobile terminal during transmitting the video frame; and changing the coding scheme of the video frame to be transmitted to the mobile terminal according to the result of analyzing the coding scheme change determining information.

### BRIEF DESCRIPTION OF THE DRAWINGS

The above and other exemplary aspects, features and advantages of the present invention will become more apparent from the following detailed description taken in conjunction with the accompanying drawings, in which:

FIG. 1 illustrates a communication system according to the present invention;

FIG. 2 is a block diagram illustrating a server according to an embodiment of the present invention;

FIG. 3 is a control flowchart illustrating a method of providing a video service from the server according to an embodiment of the present invention;

FIG. 4 is a block diagram illustrating a mobile terminal according to an embodiment of the present invention; and

FIG. 5 is a control flowchart illustrating a method of providing a video service from a mobile terminal according to an embodiment of the present invention.

### DETAILED DESCRIPTION OF THE INVENTION

Hereinafter, embodiments of the present invention will be described with reference to the accompanying drawings for explanatory purposes. As the embodiments are not the only manner in which the invention may be practiced, a person of ordinary skill in the art understands that invention is not limited to the examples shown and described. For the purposes of clarity and simplicity, a detailed description of known functions and configurations incorporated herein will be omitted when it may obscure the subject matter of the present invention by their inclusion.

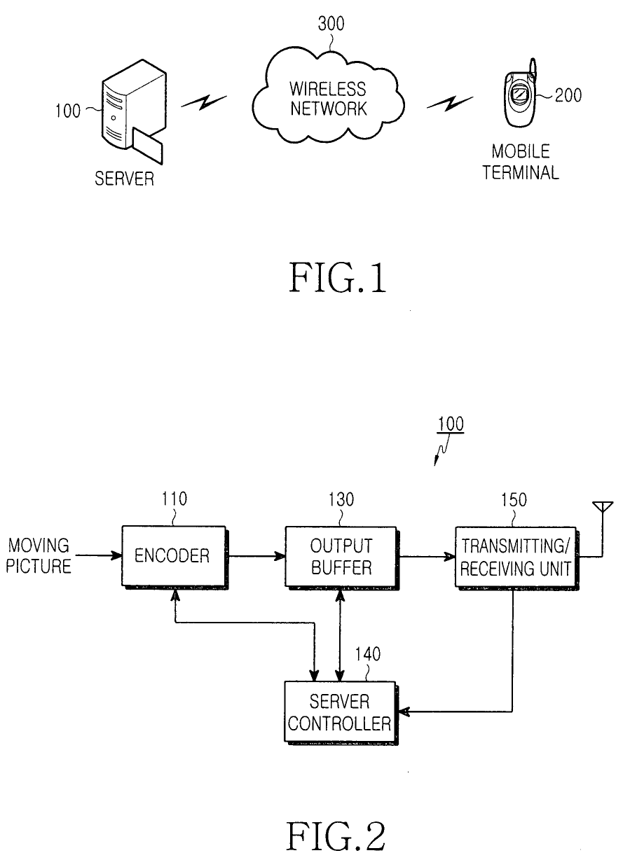

FIG. 1 illustrates one example of a communication system according to the present invention.

Referring to FIG. 1, a server 100 is connected to a mobile terminal 200 through a wireless network 300. The server 100 codes a moving picture according to a coding scheme using both an intra-coding and inter-coding scheme at a predetermined ratio and transmits the coded picture, and the mobile terminal 200 receives and decodes the coded moving picture.

In addition, according to the present invention, the mobile terminal 200 while decoding the moving picture transmitted from the server, determines whether there is an error regarding the received frame, e.g., whether there is packet loss regarding the received frame.

Further, the mobile terminal 200 can monitor an overflow or underflow occurrence. If an error occurs, the mobile terminal 200 provides the server 100 with information about an error occurrence and a position in which the error has occurred. At this time, the information identifying the position in which the error has occurred is provided for each macro block received by the mobile terminal 200. The video frame includes a plurality of macro blocks, and the coding is performed for each macro block.

Furthermore, the mobile terminal 200 transmits to the sever 100 other information, such as a received signal electric field strength or Received Signal Strength Indicator (RSSI), a Carrier to Interference and Noise Ratio_(CINR) and a buffer's own state, etc. Hereinafter, the information related to a receipt of the video frame from the mobile terminal, such as the RSSI, CINR and the buffer's own state, may be the receiving environment information.

The server 100 receives from the mobile terminal 200 the error occurrence and the position in which the error has occurred, and then performs coding according to a changed coding scheme from a subsequent macro block of the macro block in which the error has occurred. For example, the server 100 performs intra-coding from the subsequent macro block of the macro block in which the error has occurred or thereafter. Or the server 100 performs coding by adjusting the ratio of the intra-coding and the inter-coding, when the error has occurred, the ratio of the intra-coding is increased.

Still referring to FIG. 1, the server 100, in turn, receives the information regarding the reception environment from the mobile terminal 200 as described above, analyzes the reception environment information, and determines whether or not to change the coding scheme. The change in the coding scheme might be required, or optional, depending on the information about the reception environment. If the information about the reception environment includes the RSSI or CINR, the server 100 can determine how far the terminal is away from a base station. As an analyzed result, if it is determined that the mobile terminal is relatively close to the base station, the server 100 typically maintains the current coding scheme. If it is determined that the mobile terminal 200 is relatively far from the base station, the server 100 typically changes the current coding scheme because of the possibility of a packet loss, or because a packet loss ratio is high or has increased by a predetermined value.

Furthermore, according to the present invention, if the coding scheme change determining information indicates that a buffer has a large available capacity capable of storing a video frame of the terminal, the server 100 may change a current coding scheme to an intra-coding scheme that allows the information to include many coded frames.

FIG. 2 provides a block diagram of the described server 100 shown in FIG. 1. Referring to FIG. 2, the server 100 includes an encoder 110, an output buffer 130, a server controller 140 and a transmitting/receiving unit 150. Under the control of the server controller 140, the encoder 110 typically codes the video for each macro block according to a coding scheme using both the intra-coding and the inter-coding at a predetermined ratio and provides the coded video frames to the transmitting/receiving unit 150 through the output buffer 130. The transmitting/receiving unit 150 subsequently transmits the coded video frames retrieved from the output buffer 130 to the mobile terminal. Further, the transmitting/receiving unit 150 receives the coding scheme change determining information transmitted from the mobile terminal and transmits the received information to the server controller 140.

Here, the coding scheme change determining information typically includes information such as information about the reception environment of the mobile terminal (i.e. receiving environment information), an error occurrence, and the position in which the error has occurred. However the coding scheme change determining information is not limited to the aforementioned items, and it is to be understood by a person of ordinary skill in the art that any information related to the change determination on the coding scheme where the change of the coding scheme is necessary may also be included.

Still referring to FIG. 2, the server controller 140 receives the coding scheme change determining information. The coding scheme change determining information indicates a specific error occurrence and the position in which the error has occurred, and the server controller 140, in response to the coding scheme change determining information received from the mobile terminal 100 (via the wireless network 300) typically performs coding according to a changed coding scheme continuing from the macro block or the subsequent macro block of the corresponding macro block in which the error has occurred.

As an alternative to changing the coding scheme as described herein above, the server controller 140 may perform coding in which the ratio of the intra-coding and the inter-coding is changed/controlled.

Furthermore, if the coding scheme change determining information comprises some or all of the receiving environment information, the server controller 140 analyzes the receiving environment information and determines whether or not to change the coding scheme. If it is determined that the mobile terminal is within an acceptable range from (relatively close to) the base station as the result of the analysis, the server controller 140 typically maintains the current coding scheme. However, if it is determined that the mobile terminal is outside or close to an unacceptable range from the base station, the server typically changes the current coding scheme when the possibility of a packet loss, or a packet loss ratio has increased or is high (for reached a certain predetermined threshold).

As described above, the change of the coding scheme can be accomplished by performing intra-coding from the subsequent macro block of the macro block which the error has occurred or thereafter, or by decreasing the ratio of the inter-coding and increasing the ratio of the intra-coding. A person of ordinary skill in the art understands and appreciates that the changes in ratios of the inter-coding and intra-coding also potentially impacts the bandwidth requirements for transmissions, as well as storage requirements of the buffer at the server, and must also take in account the capabilities/capacities of the mobile terminal.

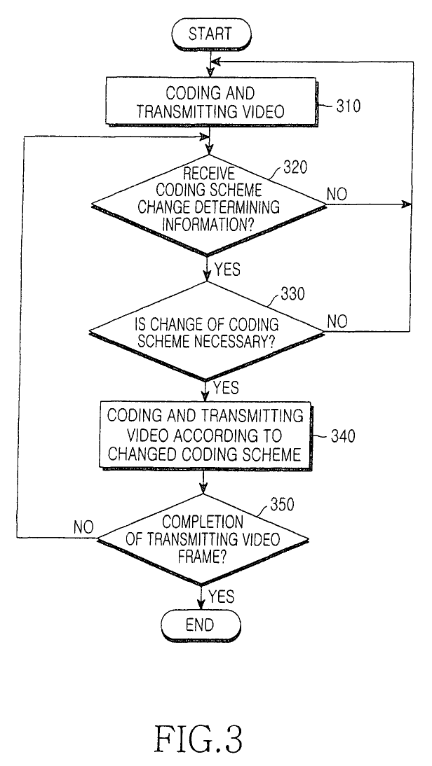

FIG. 3 provides a flow chart illustrating an example of one way control flow of the server controls changing of according scheme according to the present invention.

Referring to FIG. 3, in step 310, the server 100 (shown in FIG. 1) codes the input video for each macro block according to a certain coding scheme using both the intra-coding and inter-coding at a predetermined ratio. Thereafter, in step 320, the server 100 receives the coding scheme change determining information and at step 330 determines whether or not to receive the coding scheme change determining information transmitted from the mobile terminal 200.

With regard to step 330, after receiving the coding scheme change determining information from the mobile terminal 200 via the wireless network 300, the server 100 proceeds determines whether or not to necessitate the change of the coding scheme. If the coding scheme change determining information from the mobile terminal indicates the occurrence of an error and the position in which the error has occurred, changing of the coding scheme is typically necessary. In addition, if the coding scheme change determining information comprises or includes the receiving environment information (indicating information about the reception environment of the mobile terminal), the server determines at step 330 whether or not to necessitate the change of the coding scheme according to the context of the receiving environment information.

At step 340, if the coding scheme change determining information indicates the occurrence of an error occurrence and the position in which the error has occurred, the server 100 changes the coding scheme performed of only the macro block in which the error has occurred or thereafter. Otherwise, the server controller 140 performs coding by adjusting the ratio of the intra-coding and the inter-coding. In the above two cases, the coding scheme is changed in order for the transmitted video frames to be resistant to packet loss.

If the coding scheme change determining information comprises or includes the receiving environment information, and the receiving environment information indicates that the terminal is in a position where the possibility of the packet loss occurrence is high according to the result of analyzing the information on the receiving environment, the server 100 changes the coding scheme in order for the transmitted video frames to be resistant to packet loss.

Still referring to FIG. 3, at step 350 the server 100 determines whether or not the transmission of the video frame is complete, and if the transmission of the video frame is not complete, the server 100 performs step 320 again.

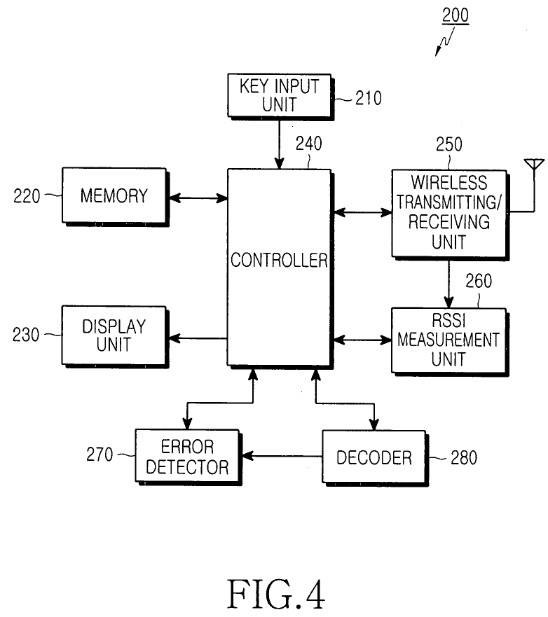

In the meantime, FIG. 4 illustrates a block diagram of the mobile terminal 200 shown in FIG. 1 and typically used with the present invention. Referring to FIG. 4, the mobile terminal includes a key input unit 210, a controller 240, a memory 220, a wireless transmitting/receiving unit 250, a RSSI measurement unit 260, a display unit 230, an error detector 270 and a decoder 280.

According to the present invention, the controller 240 of the mobile terminal 200 generally controls the functions of the mobile terminal. In addition, the transmitting/receiving unit 250 outputs received video frames to the decoder 280. The decoder 280 decodes the video frames for each macro block. If the macro block of the input video frame is coded according to an intra-coding or inter-coding scheme, the decoder 280 appropriately decodes the macro block according to the respective scheme used. The error detector 270 monitors the decoder 280 and determines whether or not an error has occurred during the decoding, typically that a packet loss occurred. If packet loss has occurred, the error detector 270 provides to the controller 240 the packet loss occurrence and the position where the packet loss occurred.

Further, the RSSI measurement unit 260 measures the RSSI, which indicates the strength of signals from the base station of the mobile terminal, and provides the measured RSSI to the controller 240. Furthermore, the mobile terminal further includes a Carrier to Interference-plus-Noise Ratio (CINR) measurement unit (not shown) if necessary to measure the CINR, and provides the measurement result to the controller 240.

The controller 240 receives information from the error detector 270 regarding the occurrence of packet loss and the position where the packet loss occurred, and the RSSI from the RSSI measurement unit 260, and then instructs the wireless transmitting/receiving unit 250 to transmit to the server 100 that is transmitting the video frames the information regarding packet loss and position, and typically the RSSI information. The server 100, in turn using the information received to make any necessary adjusts to the transmission to the mobile terminal.

As described above, the video frame typically includes a plurality of macro blocks, and the coding is performed for each macro block, so that it is preferable that the packet loss position information, i.e., the position in which the error has occurred, is the position of the macro block.

The wireless transmitting/receiving unit 250 converts voice data and control data into wireless signals and transmits the wireless signals, receives the wireless signals, and converts the received wireless signals into voice data and control data and outputs the converted data. The key input unit 210 includes a plurality of number and context keys, and provides an input of a keyword for searching for a telephone number by a user, and outputs a keyword input signal to the controller 240.

The display unit 230 may typically comprise a Liquid Crystal Display (LCD), a Thin Film Transistor (TFT), an organic electroluminescence (organic EL) or the like, and displays various data and videos under the control of the controller 240. The memory 220 includes a non-volatile memory such as a Read Only Memory (ROM), a Random Access Memory (RAM), a voice memory or the like, for storing a plurality of programs and information necessary when controlling the operation of the mobile terminal 200.

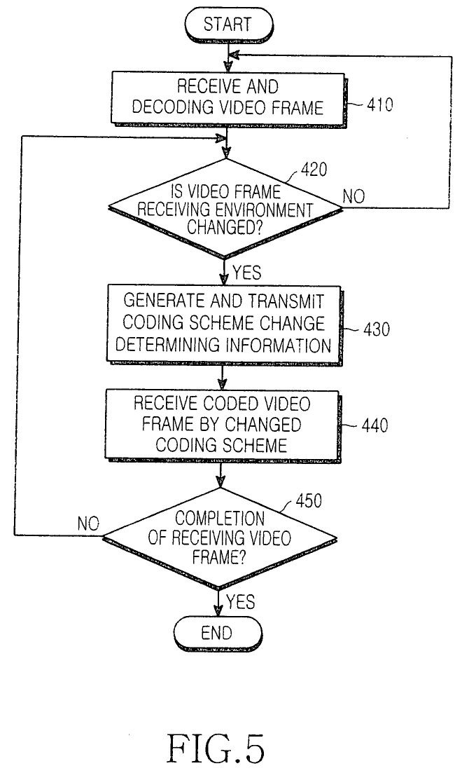

FIG. 5 provides a flowchart illustrating one example of the steps that can be used by the server to control the changing of the coding scheme according to the present invention.

Referring to FIG. 5, at step 410 the mobile terminal 200 decodes the video frames received from the server 100 for each macro block. The mobile terminal 200 appropriately decodes the macro block according to whether the input video frame is code by intra-coding or inter-coding.

At step 420, the mobile terminal 200 determines whether or not the packet loss occurred during decoding of the video frame.

At step 430, if packet loss has occurred, the mobile terminal 200 transmits to the server 100 data indicating the occurrence of the packet loss and the position where the packet loss occurred as the coding scheme change determining information. Alternatively or in addition thereto, if the mobile terminal 200 measures the RSSI, the mobile terminal 200 transmits to the server 100 the RSSI information as the coding scheme change determining information.

At step 440, the mobile terminal 200 receives from the server 100 the video frames coded by the coding scheme in a different way than the video frames coded by the previous coding scheme, and appropriately performs decoding.

At step 450, the mobile terminal 200 determines whether or not the transmission of the video frame was complete, and if the transmission of the video frame is not complete, to the method returns to step 420 to determine whether the video frame receiving information.

As described above, the present invention provides for changing the coding scheme according to the transmitting/receiving state of the video between the terminal and the server and thus can correspond to the breakdown of the video in the wireless environment.

The invention has been shown and described with reference to certain exemplary embodiments thereof. The exemplary embodiments of the present invention are applied to the server and the video transmission/reception between the server and the terminal. However, it is a matter of course that the present invention also can be applied to the video transmission/reception between servers or between terminals. Thus, the scope of the invention is not limited by the described embodiments and the scope of the invention as defined by the appended claims.

What is claimed is:

1. A method for providing a video service for a video service system which transmits a multimedia video service in real time to a mobile terminal connected through a wireless network, the method comprising:
(a) transmitting to a mobile terminal demanding a video service a first video frame coded by a coding scheme comprising both a first coding scheme type and a second coding scheme type at a predetermined ratio;
(b) receiving coding scheme change determining information from the mobile terminal for determining whether or not to change the coding scheme of the first video frame during the transmission of the video frame; and
(c) changing the coding scheme of the first video frame being transmitted to the mobile terminal according to a result of analyzing the coding scheme change determining information received in step (b).

2. The method according to claim 1, further comprising:
(d) retransmitting the first video frame in step (a) according to the coding scheme changed in step (c).

3. The method according to claim 2, further comprising:
(e) transmitting a second video frame subsequent to the first video frame retransmitted in step (d) according to the coding scheme changed in step (c).

4. The method according to claim 2, further comprising:
(e) transmitting a second video frame subsequent to the first video frame retransmitted in step (d) according to the coding scheme originally used in step (a).

5. The method according to claim 1, further comprising:
prior to transmitting the first video frame in step (a), measuring a received signal electric field strength in order to determine a distance of the mobile terminal from a base station of the wireless network for a predetermined period; and
changing the coding scheme of the first video frame to be transmitted to the mobile terminal if the measured received signal electric field strength is less than a predetermined threshold.

6. The method according to claim 1, wherein the first coding scheme type comprises an inter-coding scheme and the second coding scheme type comprises an intra-coding scheme.

7. The method according to claim 1, wherein the coding scheme change information comprises at least one of position information of a macro block in which an error has occurred among a plurality of macro blocks forming the video frame transmitted to the mobile terminal and receiving environment information indicating the received signal electric field strength based on movement of the mobile terminal.

8. The method according to claim 1, wherein the step of changing the coding scheme comprises changing a ratio of the first coding scheme type and the second coding scheme type.

9. The method according to claim 10, wherein, if the coding scheme change determining information comprises the position information of the macro block in which the error has occurred, the changing of the coding scheme changes the macro block in the position where the error has occurred among a plurality of macro blocks forming the video frame to be transmitted to the mobile terminal by the second coding scheme type.

10. The method according to claim 9, wherein the step of changing the coding scheme is performed by decreasing a ratio of the inter-coding and increasing a ratio of the intra-coding.

11. A server for providing a video service which provides a multimedia video service in real time that is transmitted to a mobile terminal connected through a wireless network, the server comprising:
an encoder for coding a video frame by a coding scheme using both a first coding scheme type and a second coding scheme type at a predetermined ratio;
a transmitting/receiving unit for transmitting one or more coded video frames to the mobile terminal and for receiving coding scheme change determining information for determining whether or not to change the coding scheme of the video frame encoded by the encoder; and
a server controller for controlling a changing of the coding scheme by the encoder according to a result of analyzing the received coding scheme change determining information.

12. The server according to claim 14, wherein the first coding scheme type comprises an inter-coding scheme and the second coding scheme type comprises an intra-coding scheme.

13. The server according to claim 14, wherein the coding scheme change information comprises at least one of position information of a macro block in which the error has occurred among a plurality of macro blocks forming the video frame transmitted to the mobile terminal and receiving environment information indicating the received signal electric field strength based on movement of the mobile terminal from a base station of the wireless network.

14. The server according to claim 16, wherein, if the coding scheme change determining information comprises the position information of the macro block in which the error has occurred, the server controller controls changing the coding scheme of the macro block in the position where the error has occurred among the plurality macro blocks forming the video frame to be transmitted to the mobile terminal.

15. The server according to claim 16, wherein, if the coding scheme change determining information comprises the position information of the macro block in which the error has occurred, the server controller controls changing the coding scheme of an entirety of the plurality macro blocks forming the video frame to be transmitted to the mobile terminal.

16. The server according to claim 14, wherein the server controller changes the coding scheme by changing the predetermined ratio of the first and second coding scheme types.

17. The server according to claim 19, wherein the first coding scheme type comprises an inter-coding scheme and the second coding scheme type comprises an intra-coding scheme.

18. The server according to claim 20, wherein the server controller changes the coding scheme by decreasing the ratio of the inter-coding and increasing the ratio of the intra-coding.

19. The server according to claim 16, wherein, if the received coding scheme change information comprises the received signal electric field strength, and the measured received signal electric field strength is less than a predetermined threshold, the server controller changes the coding scheme of the video frame to be transmitted to the mobile terminal.

20. A mobile terminal provided with a video service connected to a providing server which provides a multimedia video service in real time that is transmitted to the mobile terminal via a wireless network, comprising:
a wireless transmitting/receiving unit for receiving a wirelessly transmitted video frame coded by a coding scheme using both a first coding scheme type and a second scheme type at a predetermined ratio from the video service providing server and wirelessly transmitting a coding scheme change determining information to the video service providing server in order for the video service providing server to determine whether or not to change the coding scheme of the video frame;
a controller for controlling the coding scheme change determining information to transmit to the video providing server when an error has occurred in the video frame received by the wireless transmitting/receiving unit; and
an output unit for outputting the video frame received in the wireless transmitting/receiving unit.

21. The mobile terminal according to claim 20, wherein the first coding scheme type comprises an inter-coding scheme and the second coding scheme type comprises an intra-coding scheme.

22. The mobile terminal according to claim 20, wherein, when an error has occurred in a macro block forming the received video frame, the controller controls generating the position information of said macro block in which the error has occurred and transmitting the coding scheme change determining information comprising the position information of said macro block to the video service providing server.

23. The mobile terminal according to claim 20, which further comprises a received signal electric field strength measurement unit for measuring the received signal electric field strength based on a distance between the mobile terminal and a base station.

24. The mobile terminal as claimed in claim 20, wherein, when the video frame is received from the video service providing server during movement of the mobile terminal, the controller controls the received signal electric field strength measurement unit to measure the received signal electric field strength for one or more predetermined periods and transmit the coding scheme change determining information comprising received environment information indicating the measured received signal electric field strength to the video service providing server.

25. A method for providing a video service in a second apparatus provided with a video service wirelessly connected to a first apparatus comprising a video service providing server which provides a multimedia video service in real time, the method comprising the steps of:
determining whether or not an error has occurred when a transmitted video frame coded by a coding scheme using both a first coding scheme type and a second coding scheme type by the first apparatus at a predetermined ratio;
transmitting coding scheme change determining information to the video service providing server in order for the first apparatus to determine whether or not to change the coding scheme of the video frame when the error has occurred in the received video frame; and
receiving the video frame of which the coding scheme is changed to output.
